(19) United States
(12) Patent Application Publication
(10) Pub. No.: US 2019/0154520 A1
(43) Pub. Date: May 23, 2019

(54) OVERVOLTAGE PROTECTION WITH INDICATION OF EXCEEDED OPERATING TEMPERATURE

(71) Applicant: SALTEK S.R.O., Usti nad Labem - Krasne Brezno (CZ)

(72) Inventors: Jaromir SUCHY, Usti nad Labem (CZ); David KOMRSKA, Psary (CZ); Raul PEREZ, Velke Brezno (CZ)

(73) Assignee: SALTEK S.R.O., Usti nad Labem - Krasne Brezno (CZ)

(21) Appl. No.: 16/097,627

(22) PCT Filed: May 3, 2017
(86) PCT No.: PCT/IB2017/052554

§ 371 Date: Oct. 30, 2018

(30) Foreign Application Priority Data
May 3, 2016 (CZ) PUV 2016-32340

(51) Int. Cl. G01K 11/14; H02H 1/00

(52) U.S. Cl. CPC G01K 11/14; H01C 7/12; H02H 1/0007

(57) ABSTRACT

An overvoltage protection with indication of exceeded operating temperature, where the overvoltage protection includes at least one protection element from the group of a two-pole protection component, a two-pole protection component complemented with a temperature dependent fuse, and/or a three-pole protection component. All protection components used in the given overvoltage protection is linked via a thermal link to the status indicator including a thermosensitive layer with irreversible change of color in case a temperature of the destructed protection members of the overvoltage protection is exceeded

### BACKGROUND AND SUMMARY

The technical solution is concerned to overvoltage protection devices, with at least one protection element, installed in the low voltage wiring or data and telecommunications networks specified for protection of electrical and electronic instruments and machinery against overvoltage.

The current known designs consist of overvoltage protection used for protection of electronic and electrical equipment, they comprise protection elements, such as gas discharge tubes in two-pole or three-pole embodiment, varistors and semiconductor diodes. Protection elements are damaged due to exceeding limit values of pulse currents and/or temporary overvoltage (TOV) and/or low-value pulse currents with high frequency of occurrence. The damaged overvoltage protection loses its protection characteristics and it is necessary to replace it for a defect-free device.

According to the effective standards, overvoltage protection must be equipped with a device which can properly indicate the fact that the limit values of the protection member were exceeded.

Overvoltage protection based on varistors must also be equipped with a disconnecting device which responds to exceeding the limit values by disconnecting the varistor from the supply network, or telecommunication line. The state of disconnection of the protection member shall be indicated via a suitable indicator.

Overvoltage protection consisting of connecting a two-pole gas discharge tube and varistor with a disconnector, is used in, for example, the utility models—CZ 18902 “Varistor overvoltage protection”, CZ 19812 “Varistor overvoltage protection with compact thermal disconnector” as well as CZ 292211 “Overvoltage protection device of terminal equipment for the electrical network”. The disconnector is designed to disconnect the flexible connection contact connected with the varistor terminal soldered on with a solder with a low interval of melting if the temperature of the varistor rises above the permitted limit. The disconnection force is due to the flexibility of the thermal disconnector or spring. If parameters change in the varistor, e.g. as a result of overloading, a low current starts flowing through the varistor, after which the varistor and the soldered connection with the connecting contact heat up to the temperature when the solder starts melting. The connection loses its firmness and the flexible contact removes from the varistor terminal and disconnects it from voltage. The installed electronic circuit evaluates the failure status and the status indicator indicates the failure by disconnecting the varistor. The simplest status indicator comprises a diode which lights up, or a glow tube.

A different design is described in DE 20204673 “Schutzkontaktsteckdose”. This uses a design of a two-pole gas discharge tube and varistor. The disconnector comprises a temperature dependent fuse connected in series with a varistor. In case of a varistor failure the temperature dependent fuse disconnects, which disconnects the varistor from voltage. The evaluation of the failure status is also carried out by an electronic circuit, whose disadvantage is in this case that it constantly takes current. Failures are indicated by heating up the illuminative diode.

The disadvantage of these technical designs is their complexity and expensiveness. However, none of the above quoted documents focus on checking and indicating exceeded limit values of the two-pole gas discharge tube.

The disadvantages of the technical designs stated above are eliminated by the design according to DE 20 2012 002 281 (U1) “Überspannungsschutzgerät mit einer Messeinrichtung zur Überwachung von einem oder mehreren Überspannungsschutzelementen”, which measures and evaluates the load of the two-pole protection member GDT using optic sensors OS1, OS2 and temperature sensors TS, connected to the monitoring and assessment system CD, provided with status indicators OUT1, OUT2, or with added protection of a two-pole protection member GDT by its short-circuiting (FIG. 1, FIG. 2). Monitoring and evaluation system CD decides on the status of the overvoltage protection using logical procedure according to the network graph (FIG. 3).

The disadvantage of this design is that it is complicated and expensive. The price makes it not suitable for massively used overvoltage protection.

The above indicated disadvantages are eliminated in overvoltage protection with indication of exceeded operating temperature according to the submitted solution. The overvoltage protection comprises at least one protection element from the group of a two-pole protection component, two-pole protection component complemented with a temperature dependent fuse or a three-pole protection component. The principle of the new design is that a status indicator is linked to all protection components used in the specified overvoltage protection with a temperature link. The status indicator comprises a temperature-sensitive layer with an irreversible change of colour in case the temperature is exceeded as a result of the damage of the protection members of the specified overvoltage protection.

Protection components can be linked via the thermal link to one common status indicator, or each protection component is linked to its own status indicator via the thermal link.

The thermosensitive layer of the status indicator comprises in one possible design a paint which is directly coated on the protection components of the specific overvoltage protection, or coated on the thermo-conductive substrate positioned in a close distance from the protection members of the given overvoltage protection.

In another possible design, the thermo-sensitive layer of the status indicator consists of a film, with an advantageously self-adhesive label located directly on the protection components of the specific overvoltage protection. It is also possible to apply the film or the self-adhesive label onto the thermo-conductive substrate situated in a close distance from the protection members of the specific overvoltage protection.

The advantage of such indication of exceeded operating temperature by means of a status indicator is a simple construction, i.e. low cost and possibility to check overloading of the protection member even in cases a different technical solution is impossible, particularly in case of gas discharge tubes and semi-conductor diodes.

### BRIEF DESCRIPTION OF DRAWINGS

The technical solution will be explained in more details using the attached drawings.

FIG. 1 shows the design of an overvoltage protection with a two-pole protection element, a temperature dependent fuse and status indicator linked to each other with a thermal link.

FIG. 2 shows the design of an overvoltage protection with a two-pole protection element, a status indicator linked to each other with a thermal link without the temperature-dependent fuse.

FIG. 3 shows the design of an overvoltage protection with a three-pole protection element and status indicator linked to each other using the thermal link without a temperature-dependent fuse.

FIG. 4 shows the design of an overvoltage protection with three two-pole protection members, two temperature-dependent fuses and a status indicator linked to each other using a thermal link.

FIG. 5 shows the design of an overvoltage protection with three two-pole protection members, two temperature-dependent fuses and three status indicators linked via a thermal link to the respective protection component and/or temperature dependent fuse.

### DETAILED DESCRIPTION

Generally, the overvoltage protection comprises at least one protection element from the group of the two-pole protection component 6, two-pole protection component 6 complemented with a temperature dependent fuse 8, three-pole protection component 7. Indication of exceeded operating temperature according to the new solution consists of all protection components used in the specific overvoltage protection linked via a thermal link to a status indicator 10 which comprises a thermosensitive layer with irreversible change of colour in case the temperature of the damaged protection members of the specific overvoltage protection is exceeded.

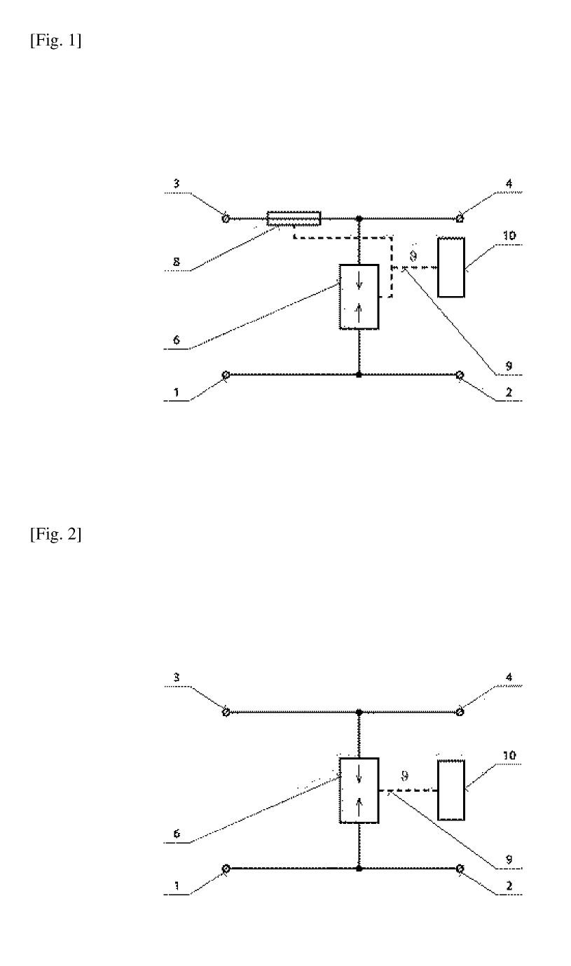

The example in FIG. 1 shows overvoltage protection which comprises one two-pole protection element 6 connected with its one end between the first input terminal 1 and the first output terminal 2. With its second end the two-pole protection component 6 is connected via a temperature dependent fuse 8 to the second input terminal 3 and, at the same time, it is interconnected with the second output terminal 4. A status indicator 10 is linked to both overvoltage protection elements via a thermal link 9. Similar design is indicated in FIG. 2 with a temperature-dependent fuse 8 left out.

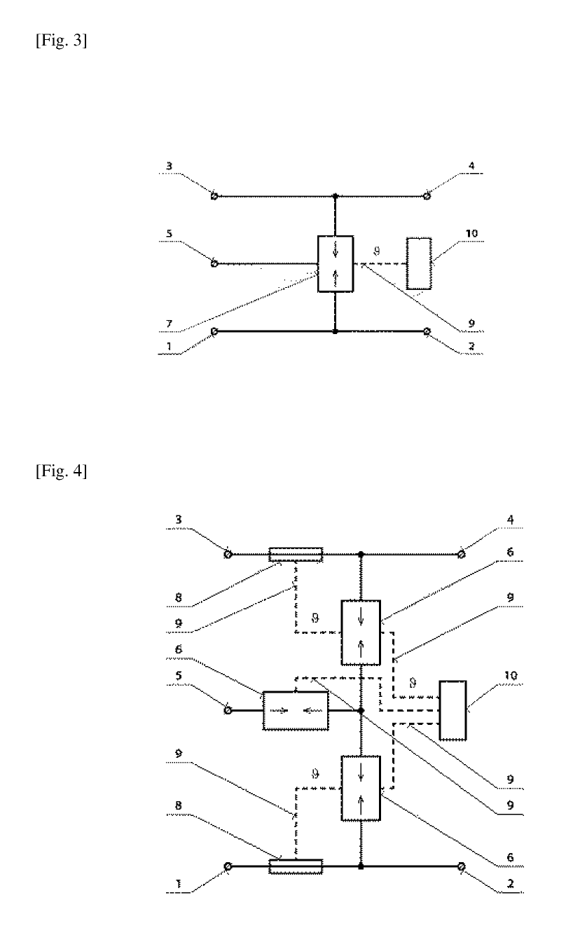

FIG. 3 shows the option of the design with a three-pole protection element 7, the medium pole of which is connected to the third input terminal 5 and to which a status indicator 10 is linked to the thermal link 9.

Another possible option is in FIG. 4. The overvoltage protection in this figure comprises three two-pole protection members 6, connected in a star without an output common junction. Two protection two-pole elements 6 are connected in series and connected with their one external end via temperature-dependent fuses 8 to the first input terminal 1, or the second input terminal 3 and, at the same time, they are interconnected with the first output terminal 2, or the second output terminal 4. The third protection two-pole element 6 is connected between their common point and the third input terminal 5. All these protection components are linked via the thermal link 9 to the single status indicator 10. FIG. 5 is an option of the design with each protection component linked via the thermal link 9 to a separate status indicator 10, whereas protective two-pole elements 6 complemented with dependent fuses 8 are considered to be one protection component.

The thermosensitive layer of the status indicator 10 may consist of a paint or a film, with an advantage in a form of a self-adhesive label. It is either applied directly onto the protection components of the specific overvoltage protection, or it can be created on the thermo-conductive substrate positioned in a close distance from the specific protection member. Should a temperature-dependent fuse 8 be used, the status indicator 10 should be located directly onto it.

In an overvoltage protection, the temperature at which the protection member is damaged, is known. Based on the temperature a specific thermosensitive layer of the status indicator 10 is chosen. If this temperature is exceeded, the protection member is damaged, and the thermosensitive layer of the status indicator 10 will permanently change its colour. It indicates the fact that the permitted temperature was exceeded, at which the temperature-dependent fuse disconnects and/or the protection member is damaged.

The protection component consisting of a varistor is connected in series in compliance with standards with the temperature dependent fuse. The thermal link 9 is then carried out between all elements in such a manner that they are located next to each other and touch each other.

Many other used types of design protection can be considered apart from those shown in the examples, and the status indicator can be used for all of them.

### INDUSTRIAL APPLICABILITY

The overvoltage protection with indication of exceeded operating temperature according to the submitted solution is a product which can be used where protection of electronic equipment and instruments from overvoltage is necessary, e.g. in installations of modern LED lighting systems, converters of photovoltaic systems, etc.

1. An overvoltage protection with indication of exceeded operating temperature, where the overvoltage protection comprises at least one protection element from the group of a two-pole protection component, a two-pole protection component complemented with a temperature dependent fuse, a three-pole protection component comprising all protection components used in the given overvoltage protection is linked via a thermal link to a status indicator consisting of a thermosensitive layer with irreversible change of colour in case a temperature of the destructed protection members of the overvoltage protection is exceeded.

2. The overvoltage protection according to claim 1, wherein all protection components are linked via the thermal link to one common status indicator.

3. The overvoltage protection according to claim 1, wherein each protection component is linked via the thermal link to its own status indicator.

4. The overvoltage protection according to claim 2, wherein the thermosensitive layer of the status indicator consisting of a paint coated directly onto protection components of the overvoltage protection.

5. The overvoltage protection according to claim 2, wherein the thermosensitive layer of the status indicator consists of the paint coated onto the thermos-conductive substrate located in a close distance from the protection members of the overvoltage protection.

6. The overvoltage protection according to claim 2, wherein the thermosensitive layer of the status indicator consists of a film, with the advantage of a self-adhesive label located directly on the protection components of the overvoltage protection.

7. The overvoltage protection according to claim 2, wherein the thermosensitive layer of the status indicator consists of the film, with the advantage of the self-adhesive label located on the thermos-conductive substrate located in a close distance from the protection members of the overvoltage protection.
